(19) United States
(12) Patent Application Publication
(10) Pub. No.: US 2026/0203881 A1
(43) Pub. Date: Jul. 16, 2026

(54) AI-BASED MULTI-FRAME IMAGE PROCESSING

(71) Applicant: Samsung Electronics Co., Ltd., Suwon-si (KR)

(72) Inventors: Nguyen Thang Long Le, Garland, TX (US); Tyler Luu, Richardson, TX (US); Hamid Rahim Sheikh, Allen, TX (US)

(21) Appl. No.: 19/312,051

(22) Filed: Aug. 27, 2025

Related U.S. Application Data
(60) Provisional application No. 63/745,467, filed on Jan. 15, 2025.

(51) Int. Cl. G06T 5/92; G06T 3/18; G06T 3/4015; G06T 5/50; G06T 5/70; G06T 7/20; G06V 10/24

(52) U.S. Cl. CPC G06T 5/92; G06T 3/18; G06T 3/4015; G06T 5/50; G06T 5/70; G06T 7/20; G06V 10/24; G06T 2207/20208; G06T 2207/20221

(57) ABSTRACT

A method includes converting each of multiple image frames at a first exposure level to YUV image frames and to RGB image frames. The method also includes generating aligned color filter array images using the RGB image frames. The method also includes generating, by a first artificial intelligence model, a single-frame blended RGB image at the first exposure level. The method also includes generating a single-frame blended negative color filter array image using aligned negative color filter array images, wherein the aligned negative color filter array images are generated using multiple negative image frames at various exposure levels. The method also includes generating, by a second artificial intelligence model using the single-frame blended negative color filter array image, a single-frame blended negative RGB image. The method also includes blending the single-frame blended RGB image at the first exposure level and the single-frame blended negative RGB image.

### CROSS-REFERENCE TO RELATED APPLICATION AND PRIORITY CLAIM

This application claims priority under 35 U.S.C. § 119 (e) to U.S. Provisional Patent Application No. 63/745,467 filed on Jan. 15, 2025, which is hereby incorporated by reference in its entirety.

### TECHNICAL FIELD

This disclosure relates generally to image processing systems and processes. More specifically, this disclosure relates to artificial intelligence (AI)-based multi-frame image processing.

### BACKGROUND

Many mobile electronic devices, such as smartphones and tablet computers, include cameras that can be used to capture still and video images. In some cases, electronic devices can capture multiple image frames of the same scene, such as at different exposure levels, and blend the image frames to produce a high dynamic range (HDR) image of the scene. The HDR image generally has a larger dynamic range than any of the individual image frames. These techniques are often referred to as multi-frame processing (MFP) techniques. Among other things, blending the image frames to produce the HDR image can help to incorporate greater image details into both darker regions and brighter regions of the HDR image while reducing noise.

### SUMMARY

This disclosure relates to AI-based multi-frame image processing.

In one embodiment, a method includes obtaining, using at least one processing device of an electronic device, multiple image frames at a first exposure level and multiple negative image frames, wherein the multiple negative image frames are at various exposure levels. The method also includes converting each of the multiple image frames at the first exposure level to YUV image frames and to RGB image frames. The method also includes generating motion maps using the YUV image frames. The method also includes generating aligned color filter array images using the RGB image frames. The method also includes generating, by a first artificial intelligence model using the motion maps and the aligned color filter array images, a single-frame blended RGB image at the first exposure level. The method also includes generating a single-frame blended negative color filter array image using aligned negative color filter array images, wherein the aligned negative color filter array images are generated using the multiple negative image frames. The method also includes generating, by a second artificial intelligence model using the single-frame blended negative color filter array image, a single-frame blended negative RGB image. The method also includes blending the single-frame blended RGB image at the first exposure level and the single-frame blended negative RGB image to create a high dynamic range (HDR) image. The method also includes performing tone mapping on the HDR image to generate a low dynamic range (LDR) image for display.

In another embodiment, an electronic device includes at least one processing device configured to obtain multiple image frames at a first exposure level and multiple negative image frames, wherein the multiple negative image frames are at various exposure levels. The at least one processing device is also configured to convert each of the multiple image frames at the first exposure level to YUV image frames and to RGB image frames. The at least one processing device is also configured to generate motion maps using the YUV image frames. The at least one processing device is also configured to generate aligned color filter array images using the RGB image frames. The at least one processing device is also configured to generate, by a first artificial intelligence model using the motion maps and the aligned color filter array images, a single-frame blended RGB image at the first exposure level. The at least one processing device is also configured to generate a single-frame blended negative color filter array image using aligned negative color filter array images, wherein the aligned negative color filter array images are generated using the multiple negative image frames. The at least one processing device is also configured to generate, by a second artificial intelligence model using the single-frame blended negative color filter array image, a single-frame blended negative RGB image. The at least one processing device is also configured to blend the single-frame blended RGB image at the first exposure level and the single-frame blended negative RGB image to create a high dynamic range (HDR) image. The at least one processing device is also configured to perform tone mapping on the HDR image to generate a low dynamic range (LDR) image for display.

In another embodiment, a non-transitory machine readable medium comprises instructions that when executed cause at least one processor of an electronic device to obtain multiple image frames at a first exposure level and multiple negative image frames, wherein the multiple negative image frames are at various exposure levels, convert each of the multiple image frames at the first exposure level to YUV image frames and to RGB image frames, generate motion maps using the YUV image frames, generate aligned color filter array images using the RGB image frames, generate, by a first artificial intelligence model using the motion maps and the aligned color filter array images, a single-frame blended RGB image at the first exposure level, generate a single-frame blended negative color filter array image using aligned negative color filter array images, wherein the aligned negative color filter array images are generated using the multiple negative image frames, generate, by a second artificial intelligence model using the single-frame blended negative color filter array image, a single-frame blended negative RGB image, blend the single-frame blended RGB image at the first exposure level and the single-frame blended negative RGB image to create a high dynamic range (HDR) image, and perform tone mapping on the HDR image to generate a low dynamic range (LDR) image for display.

Any one or any combination of the following features may be used with the first, second, and/or third embodiments. Generating the motion maps using the YUV image frames may include aligning the YUV image frames using a first warp operation and generating the motion maps from the aligned YUV image frames, generating the aligned color filter array images using the RGB image frames may include aligning the RGB image frames using a second warp operation and generating the aligned color filter array images from the aligned RGB image frames, and the aligned negative color filter array images may be generated from the multiple negative image frames using a third warp operation. The aligned color filter array images, the aligned negative color filter array images, and the single-frame blended negative color filter array image may be Bayer images. The aligned color filter array images, the aligned negative color filter array images, and the single-frame blended negative color filter array image may be Tetra images. The first artificial intelligence model may be trained via the following: a training pair is obtained, wherein the training pair includes a ground truth RGB frame and input color filter array image frames; motion noise augmentation is applied to the input color filter array image frames; random patches are extracted from the ground truth RGB frame and the input color filter array image frames; motion blur augmentation with a first probability is applied to the input color filter array image frames; warp and halo blur augmentation with a second probability is applied to the input color filter array image frames; and the input color filter array image frames are encoded as RGB frames to encourage residual learning. The second artificial intelligence model may be trained via the following: a training pair is obtained, wherein the training pair includes a ground truth RGB frame and input color filter array image frames; random patches are extracted from the ground truth RGB frame and the input color filter array image frames; halo blur augmentation is applied to the input color filter array image frames; the input color filter array image frames are averaged into a single input color filter array image; and the single input color filter array image is encoded as an RGB frame to encourage residual learning. The first and second artificial intelligence models may be trained via the following: a ground truth RGB frame and input color filter array image frames are generated, wherein the ground truth RGB frame is generated using a multi-frame processing simulator to jointly combine and demosaic multi-frame long exposure-time data into a single high resolution RGB image, and wherein the input color filter array image frames are generated using the multi-frame processing simulator to perform lens shading correction and warping on multi-frame short exposure-time data. The multi-frame processing simulator can further be used to digitally bin the multi-frame short exposure-time data into low resolution color filter array image frames.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IOT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example pipeline for AI-based multi-frame processing (MFP) in accordance with this disclosure;

FIG. 3 illustrates another example pipeline for AI-based MFP in accordance with this disclosure;

FIG. 4 illustrates an example artificial intelligence model architecture in accordance with this disclosure;

FIG. 5 illustrates an example artificial intelligence model architecture in accordance with this disclosure;

FIG. 6 illustrates an example AI center (AIC) former block in accordance with this disclosure;

FIG. 7 illustrates an example method for multi-frame AI training in accordance with this disclosure;

FIG. 8 illustrates an example RGB encoding process is performed in accordance with this disclosure;

FIG. 9 illustrates an example method for applying motion blur augmentation in accordance with this disclosure;

FIG. 10 illustrates an example application of motion blur augmentation in accordance with this disclosure;

FIG. 11 illustrates an example process for motion blur augmentation with GT-based blur in accordance with this disclosure;

FIG. 12 illustrates an example method for applying warp augmentation in accordance with this disclosure;

FIG. 13 illustrates an example process for a direct Bayer warp operation in accordance with this disclosure;

FIG. 14 illustrates an example method for applying halo blur augmentation in accordance with this disclosure;

FIG. 15 illustrates an example method for single-frame AI training in accordance with this disclosure;

FIG. 16 illustrates an example process for generating training data in accordance with this disclosure;

FIG. 17 illustrates another example process for generating training data in accordance with this disclosure;

FIG. 18 illustrates another example process for generating training data in accordance with this disclosure; and

FIG. 19 illustrates an example AI-based MFP method in accordance with this disclosure.

### DETAILED DESCRIPTION

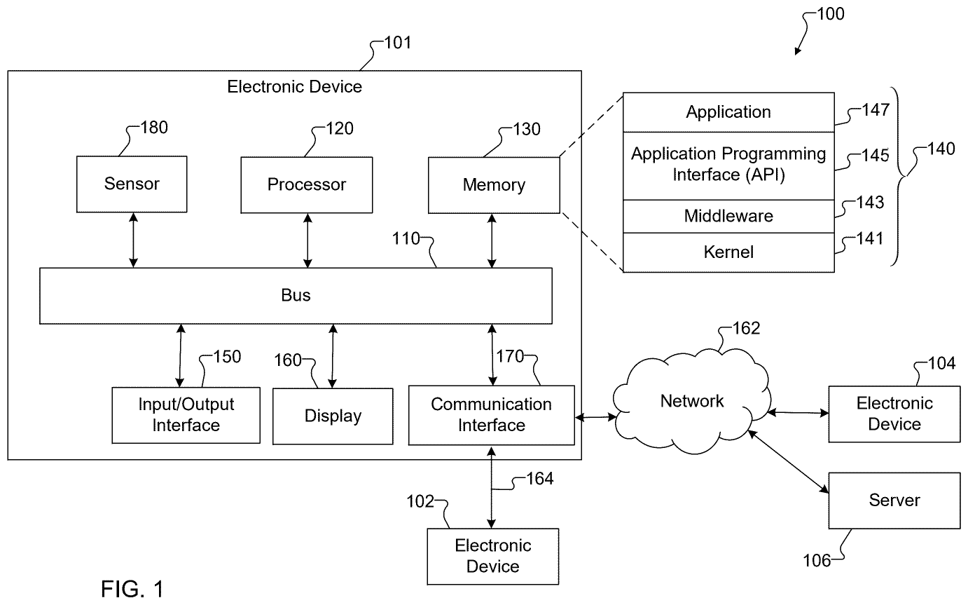

FIGS. 1 through 19, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, many mobile electronic devices, such as smartphones and tablet computers, include cameras that can be used to capture still and video images. In some cases, electronic devices can capture multiple image frames of the same scene, such as at different exposure levels, and blend the image frames to produce a high dynamic range (HDR) image of the scene. The HDR image generally has a larger dynamic range than any of the individual image frames. These techniques are often referred to as multi-frame processing (MFP) techniques. Among other things, blending the image frames to produce the HDR image can help to incorporate greater image details into both darker regions and brighter regions of the HDR image while reducing noise.

Traditional MFP pipelines analyze and combine multiple noisy input raw images to generate a high-quality single frame raw image, from which single-frame artificial intelligence (AI) technology can be applied to process the single frame raw image into a final single frame RGB image, in a process known as demosaicing.

Unfortunately, various multi-frame processing techniques can suffer from a number of shortcomings. For example, current AI demosaicing networks can be trained to perform an image restoration task, which generates the single frame RGB image from a single noisy input raw images. There has been generally two main tracks of image restoration task: low-light imaging and super-resolution. The focus in low-light imaging has been reducing camera/sensor noise and improving signal-to-noise ratio (SNR). Even where an AI demosaicing network has been trained to reduce camera/sensor noise and improve SNR in low-light imaging, the low-light imaging restoration results in a cleaner image (e.g., higher SNR), but the resultant image can suffer from chroma artifacts around bright regions, and/or thick edges around light sources, which gives a sense of blurriness to the resultant single frame RGB image. Also, a focus in super-resolution has been improving resolution rendering in bright light/low noise scenarios. However, even though using an AI demosaicing network trained to improve resolution rendering in bright light/low noise scenarios can result in a sharper image (e.g., higher resolution), the AI demosaic network can only be applied to low noise scenarios, limiting the number of useful applications.

This disclosure provides various techniques for unifying the MFP pipeline and the AI demosaicing operations into an end-to-end AI MFP network to alleviate the above issues. For example, in some embodiments of this disclosure, multiple image frames at a first exposure level and multiple negative image frames at various exposure levels may be obtained. Each of the multiple image frames at the first exposure level may be converted to YUV image frames and to RGB image frames, and motion maps using the YUV image frames may be generated. Aligned color filter array images may also be generated using the RGB image frames.

Also, in some embodiments of this disclosure, a first artificial intelligence model may use the motion maps and the aligned color filter array images to generate a single-frame blended RGB image at the first exposure level. A single-frame blended negative color filter array image may also be generated using aligned negative color filter array images, and the aligned negative color filter array images may be generated using the multiple negative image frames. Additionally, a second artificial intelligence model may use the single-frame blended negative color filter array image to generate a single-frame blended negative RGB image. The single-frame blended RGB image at the first exposure level and the single-frame blended negative RGB image may be blended to create a high dynamic range (HDR) image, and tone mapping may be performed on the HDR image to generate a low dynamic range (LDR) image for display on an electronic device.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to AI-based multi-frame image processing.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to AI-based multi-frame image processing. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to AI-based multi-frame image processing.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

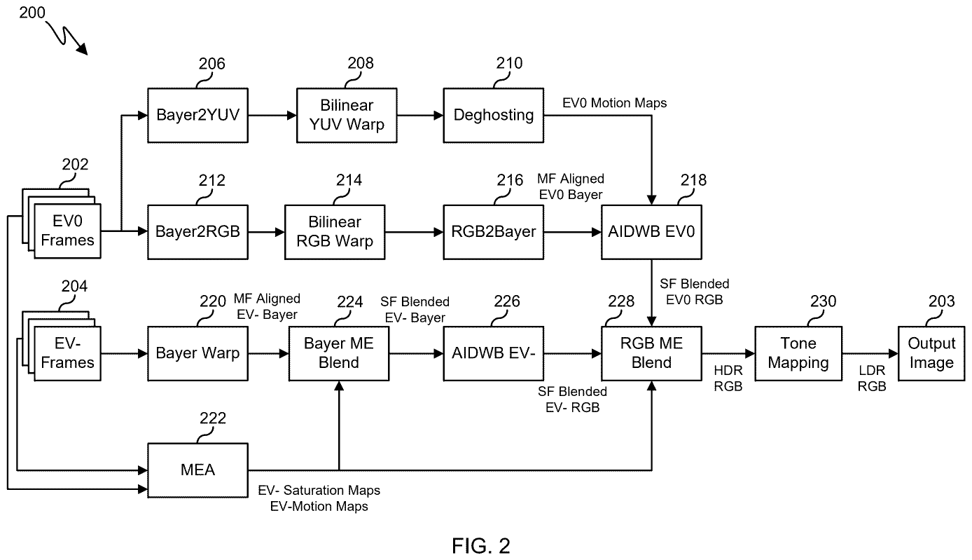

FIG. 2 illustrates an example pipeline 200 for AI-based multi-frame processing (MFP) in accordance with this disclosure. For ease of explanation, the pipeline 200 shown in FIG. 2 may be implemented on or supported by the electronic device 101 in the network configuration 100 of FIG. 1. However, the pipeline 200 shown in FIG. 2 could be used with any other suitable device(s) (such as the server 106) and in any other suitable system(s).

As shown in FIG. 2, the pipeline 200 generally receives and processes two sets of input image frames, a set of input image frames at a first exposure level (EV0 frames 202) and a set of negative input image frames at various exposure levels (EV-frames 204). The sets of input image frames may include image frames captured in rapid succession or at substantially the same time. The sets of input image frames may be obtained from any suitable source(s), such as when the input image frames are captured using at least one camera or other imaging sensor 180 of the electronic device 101 during an image capture operation. The sets of input image frames here may include any suitable number of input image frames. Each input image frame can have any suitable resolution, such as up to fifty megapixels or more. In some embodiments, the input image frames represent raw image frames. Raw image frames typically refer to image frames that have undergone little if any processing after being captured. The availability of raw image frames can be useful in a number of circumstances since the raw image frames can be subsequently processed to achieve the creation of desired effects in output images. In many cases, for example, the input image frames can have a wider dynamic range or a wider color gamut that is narrowed during image processing operations in order to produce still or video image frames suitable for display or other use. Each input image frame can have any suitable format, such as a Bayer or other raw image format, a red-green-blue (RGB) image format, or a luma-chroma (YUV) image format.

In some embodiments, the input image frames may include image frames captured using different capture conditions. The capture conditions can represent any suitable settings of the electronic device 101 or other device used to capture the input image frames 202. For example, the capture conditions may represent different exposure settings of the imaging sensor(s) 180 used to capture the input image frames, such as different exposure times or ISO settings. In multi-frame processing pipelines, for example, multiple input image frames may be captured using different exposure settings so that portions of different input image frames can be combined to produce an HDR output image or other blended image.

The pipeline 200 can be part of an AI MFP network to generate a single frame RGB image (output image 203) from multiple noisy input raw images. As noted above, the multiple noisy input raw images can include multiple EV0 frames 202 and multiple negative EV frames 204 (the “EV-frames”). For example, the EV-frames 204 can include frames at multiple exposure levels, such as EV-2, EV-4, EV-6, etc. frames.

The input image frames 202 are processed using various operations in the pipeline 200. For example, the pipeline 200 can include a first format conversion operation 206 that operates on each of the EV0 frames 202 to convert each of the EV0 frames 202 to YUV format, such as by performing a Bayer-to-YUV format conversion on each EV0 frame 202. This results in generating multiple YUV images, where each YUV frame has a corresponding EV0 frame 202 from which it was generated. Typically, the Y image is half-resolution compared to the original Bayer image. The UV components are often interleaved and at half-resolution compared to the Y image.

Operation 206 can thus be a Bayer2YUV operation, which is a process to convert raw Bayer pattern data into a YUV color format. This operation can be used in digital cameras and imaging systems where the sensor captures raw data in a Bayer pattern, which consists of a mosaic of red, green, and blue filters arranged in a specific pattern (e.g., RGGB, BGGR, GRBG, or GBRG). A Bayer2 YUV operation can perform (1) demosaicing, (2) RGB to YUV conversion, and (3) chroma subsampling.

The first demosaicing step interpolates the missing color values from the Bayer pattern to reconstruct a full RGB image. This process is known as demosaicing or debayering. Various algorithms can be used for demosaicing, such as bilinear interpolation, edge-directed interpolation, or more advanced methods like Malvar-He-Cutler, although this disclosure is not limited to any particular demosaicing algorithm. The second RGB to YUV conversion step can include, once the full RGB image is obtained, converting to the YUV color space. YUV separates the luminance (Y) from the chrominance (U and V), which is useful for image compression and processing. The conversion from RGB to YUV is typically done using a matrix transformation. The third chroma subsampling step is optional. In many applications, chrominance components (U and V) are subsampled to reduce the amount of data while maintaining image quality. Subsampling formats can include 4:2:0, 4:2:2, or 4:4:4.

The pipeline also includes a first warp operation 208 that aligns the YUV images output by operation 206. For instance, the first warp operation 208 can be configured to perform a bilinear warp on the multiple YUV images using an alignment map and/or mesh on the YUV input to align the YUV images. The first warp operation can be, as shown in FIG. 2, a bilinear YUV warp operation, which is a technique used in image processing to transform YUV images using bilinear interpolation. This method is particularly useful for resizing, rotating, or aligning images while preserving smooth transitions and minimizing artifacts. Bilinear interpolation is an approach for resampling images, and when applied to YUV format, it ensures that the luminance (Y) and chrominance (U and V) components are processed consistently.

Key concepts of a bilinear YUV warp operation that can be used for the operation 208 include the YUV color space. The YUV color space separates the luminance (Y) from the chrominance (U and V), which allows for efficient image compression and processing. The luminance component (Y) carries most of the image detail, while the chrominance components (U and V) carry color information. Key concepts of a bilinear YUV warp operation that can be used for the operation 208 also include bilinear interpolation. Bilinear interpolation is a method used to estimate pixel values at non-integer positions by considering the four nearest pixels in the original image. It calculates a weighted average of these four pixels based on their proximity to the target position. A formula for bilinear interpolation can be represented as follows.

$$f ( x , y ) = \frac{1}{( {x}_{2} - {x}_{1} ) ( {y}_{2} - {y}_{1} )} [ f ( {Q}_{11} ) ( {x}_{2} - x ) ( {y}_{2} - y ) + f ( {Q}_{21} ) ( x - {x}_{1} ) ( {y}_{2} - y ) + f ( {Q}_{12} ) ( {x}_{2} - x ) ( y - {y}_{1} ) + f ( {Q}_{22} ) ( x - {x}_{1} ) ( y - {y}_{1} ) ]$$

Here, Q₁₁, Q₂₁, Q₁₂, Q₂₂ are the four nearest pixels.

The bilinear YUV warp operation can involve applying bilinear interpolation separately to the Y, U, and V components of the YUV image. This ensures that the luminance and chrominance are transformed consistently, maintaining color fidelity and smooth transitions in the warped image. This process can include (1) coordinate transformation and (2) interpolation. Coordinate transformation includes mapping the original pixel coordinates to the new coordinate system based on the desired transformation (e.g., scaling, rotation, or translation). Interpolation includes applying bilinear interpolation to each Y, U, and V component to estimate pixel values at the new coordinates.

The pipeline further includes a deghosting operation 210 that analyzes the aligned YUV images to generate an EV0 motion map for each non-reference YUV image with respect to a reference YUV image (selected from the multiple YUV images provided as input to operation 210). For example, (N-1) EV0 motion maps can be generated for N YUV images provided as input to operation 210.

The EV0 frames 202 are also separately processed to create multi-frame aligned EV0 color filter array images, e.g., Bayer images. A second format conversion operation 212 operates on each of the EV0 frames 202 to convert the EV0 frames to RGB frames, such as by performing a Bayer to RGB conversion for each of EV0 frames 202. This results in multiple RGB images, where each RGB frame has a corresponding EV0 frame from which it was generated. As an example, the operation 212 can be a demosaic operation using Gradient Based Threshold Free (GBTF) interpolation. The RGB image can be at the same resolution as the original Bayer image. The operation 212 can thus be a Bayer2RGB operation as shown in FIG. 2, which is similar in operation to a Bayer2YUV operation (operation 206), but for an RGB domain target.

A second warp operation 214 aligns the RGB images, such as by performing a bilinear warp on the multiple RGB images using an alignment map and/or mesh. As shown in FIG. 2, the operation 214 can be a bilinear RGB warp operation, which is similar in operation to a bilinear YUV warp that can be used for operation 208, but for an RGB domain target. Then, to create the multi-frame EV0 color filter array images, a third conversion operation 216 is performed to convert the aligned RGB images back to color filter array images (e.g., Bayer images) that are the multi-frame EV0 color filter array images. Operation 216 can include performing a remosaic operation to obtain the multiple aligned EV0 color filter array images.

Operation 216 can thus be an RGB2Bayer operation, as shown in FIG. 2, which is a process used in image processing to convert a full RGB image into a raw Bayer pattern image. This operation is typically employed in scenarios where the RGB image needs to be transformed back into the format used by camera sensors, such as when simulating sensor data or preparing images for further processing in a pipeline that expects Bayer pattern input. An RGB image consists of three color channels (Red, Green, and Blue) for each pixel, providing complete color information. The Bayer pattern is a color filter array used in digital cameras to capture color information. It consists of a mosaic of red, green, and blue filters arranged in a specific pattern (e.g., RGGB, BGGR, GRBG, or GBRG). Each pixel in the Bayer pattern captures only one color component.

An RGB2Bayer conversion operation can involve downsampling the full RGB image into a Bayer pattern by selecting the appropriate color values for each pixel based on the Bayer filter arrangement. For example, in an RGGB Bayer pattern, the top-left pixel of the Bayer pattern will take the red value from the corresponding pixel in the RGB image, and the pixel to its right will take the green value, and so on. This process effectively reduces the color resolution of the image while preserving luminance information. Steps in an RGB to Bayer conversion operation can include: (1) downsampling, in which the RGB image is downsampled to match the resolution of the Bayer pattern, which also involves selecting one pixel from each color channel for every position in the Bayer pattern; (2) color selection, in which, for each pixel in the Bayer pattern, the corresponding color value (R, G, or B) is selected from the RGB image based on the Bayer filter arrangement; and (3) output, in which the resulting image is a raw Bayer pattern image, which contains only one color component per pixel and where demosaicing is used to reconstruct a full-color image.

The EV0 motion maps provided by operation 210 and the multiple aligned EV0 Bayer frames provided by operation 216 are provided to a first artificial intelligence model 218, e.g., an AI demosaic-warp-blend (DWB) network, as shown in FIG. 2. The first artificial intelligence model 218 takes the EV0 motion maps and the multiple aligned EV0 Bayer frames and generates a single frame blended EV0 RGB image.

The artificial intelligence model 218 generally operates to blend the aligned image frames using the deghosting information (EV0 motion maps) in order to generate a blended image (the SF blended EV0 RGB image). For example, the artificial intelligence model 218 may be trained to combine different portions of the aligned image frames based on the received motion maps. Among other things, this can allow the artificial intelligence model 218 to retain portions of non-reference image frames that exhibit a lower degree of motion and to in-paint or otherwise incorporate portions of a reference image frame into portions of the non-reference frames that exhibit a higher degree of motion. The artificial intelligence model 218 may also be trained to combine different portions of the aligned image frames so that the resulting blended image has improved image details, as described in this disclosure.

The EV-frames 204 are also processed by the pipeline 200 to create a single frame (SF) blended EV-RGB image. To create the SF blended EV-RGB image, the EV-frames 204 are provided to a third warp operation 220. The operation 220 operates on each of the EV-frames 204 to align the EV-frames 204, such as by performing a direct Bayer warp using an alignment map and/or mesh. The output of operation 220 are multiple aligned EV-color filter array images, such as Bayer images. A Bayer warp operation is a technique used in image processing, particularly in the context of camera sensors and image alignment. It involves transforming raw Bayer pattern data from one coordinate system to another, often as part of image alignment or stitching processes. This operation is essential when dealing with images captured from different perspectives or focal lengths, such as in multi-camera systems or panoramic image creation. Warping refers to the process of transforming an image from one coordinate system to another. This can involve scaling, rotation, translation, or more complex transformations like perspective changes. A Bayer warp operation applies a transformation to the raw Bayer pattern data before demosaicing. This ensures that the alignment of color channels is preserved after the transformation. A Bayer warp operation can involve: (1) interpolation, which, since the Bayer pattern contains incomplete color information, is used to estimate the missing values at new locations after warping; and (2) transformation, where the raw Bayer data is mapped to a new coordinate system based on the desired transformation (e.g., rotation, scaling, or perspective change).

A multi-exposure alignment (MEA) operation 222 of the pipeline 200 analyzes both sets of input frames (EV0 frames 202 and EV-frames 204) and generates EV-motion and EV-saturation maps that are used in operations 224 and 228 shown in FIG. 2.

In a blending operation 224, the multiple aligned EV-color filter array frames are aligned using the corresponding motion and saturation maps provided by operation 222. The output of operation 224 is a single blended EV-color filter array (e.g., Bayer) frame. A second artificial intelligence model 226, which can be an AI DWB network, takes in the single blended EV-color filter array frame and outputs a single EV-RGB frame, e.g., via a demosaic operation. An RGB-domain blending operation 228 then performs an RGB-domain blending of the EV0 RGB image from the first artificial intelligence model 218 and the EV-RGB image from the second artificial intelligence model 226 into a high dynamic range (HDR) RGB image. A tone mapping operation 230 then tone maps the HDR RGB image into a low dynamic range (LDR) RGB image (output image 203) for final display, such as on the display 160 of the electronic device 101.

In some embodiments, the tone mapping operation 230 is used to adjust the luminance values of an image, typically to map high dynamic range (HDR) data into a displayable range suitable for low dynamic range (LDR) devices. This process is essential for rendering HDR images on standard monitors, cameras, or other devices that cannot display the full range of luminance values captured in an HDR image. HDR refers to images that capture a wide range of luminance values, often exceeding what standard displays can show. HDR images preserve details in both very bright and very dark areas. LDR refers to the limited range of luminance values that standard displays can show, typically represented by 8-bit or 10-bit color depth.

In various embodiments, the tone mapping operation 230 can involve tone mapping operators, which are algorithms used to compress the luminance range of an HDR image into an LDR range while preserving visual details and maintaining a natural appearance. Tone mapping operators can include: global tone mapping, which applies a single transformation to the entire image, preserving overall contrast but potentially losing local details; and local tone mapping, which applies different transformations to different regions of the image, preserving local contrast and details but potentially introducing artifacts. The tone mapping process can involve several steps, including: (1) luminance calculation, in which the luminance (Y) of each pixel in the HDR image is computed using a weighted combination of the RGB channels; (2) normalization, in which the luminance values are normalized to a range suitable for tone mapping; (3) compression, in which a compression function is applied to map the normalized luminance values into the LDR range; and (4) color adjustment, in which the color channels are adjusted based on the tone-mapped luminance values to ensure color consistency.

In some embodiments, the tone mapping operation 230 can generally operate to adjust colors in the blended image. This can be useful or important in various applications, such as when generating HDR images. For example, since generating an HDR image often involves capturing multiple images of a scene using different exposures and combining the captured images to produce the HDR image, this type of processing can often result in the creation of unnatural tone within the HDR image. The tone mapping operation 230 can therefore use one or more color mappings to adjust the colors contained in the blended image. The output image 203 can represent a final image of the scene. In some cases, the output image 203 may undergo one or more additional post-processing operations (if desired) to produce a final image of the scene. The tone mapping operation 230 may use any suitable technique(s) to perform tone mapping, such as one or more global tone mapping techniques and/or one or more local tone mapping techniques. As a particular example, the tone mapping operation 230 may multiply each pixel of the blended image by a corresponding gain value to help ensure that the resulting output image 203 can be displayed appropriately. Note, however, that this disclosure is not limited to any particular technique(s) for tone mapping.

Operations similar to operation 206, are detailed in U.S. Patent Application Publication No. 2024/0221130, which is incorporated by reference herein. Operations similar to operation 210 are detailed in U.S. Pat. No. 11,062,436, which is incorporated by reference herein. Operations similar to operation 208, and operation 214 are detailed at https://www.mathworks.com/help/visionhdl/ug/image-warp.html, which is incorporated by reference herein. Operations similar to operation 216 are detailed at https://www.mathworks.com/matlabcentral/fileexchange/24047-remosaic-of-rgb-image-array, which is incorporated by reference herein. Operations similar to operation 220 are detailed in U.S. Patent Application Publication No. 2023/0035482, which is incorporated by reference herein. Operations similar to operations 224 and 226 are detailed in U.S. Pat. No. 11,128,809, which is incorporated by reference herein. Operations similar to the tone mapping operation 230 are detailed in WIPO Publication No. WO2024158126, which is incorporated by reference herein.

Although FIG. 2 illustrates one example of a pipeline 200 for AI-based MFP, various changes may be made to FIG. 2. For example, various components or operations in FIG. 2 may be combined, further subdivided, replicated, rearranged, or omitted according to particular needs. Also, various additional components or operations may be used in FIG. 2. Further, the pipeline 200 may be used to process any number of sets of input image frames 202, 204 in order to generate any number of output images 203. In addition, the specific pipeline 200 described above is for illustration and explanation only. Various image processing pipelines and other pipelines have been developed, and additional pipelines are sure to be developed in the future. This disclosure is not limited to any specific implementation of an image processing pipeline. In general, the techniques for AI-based MFP that are described in this patent document may be used in any other image processing pipeline or other architecture.

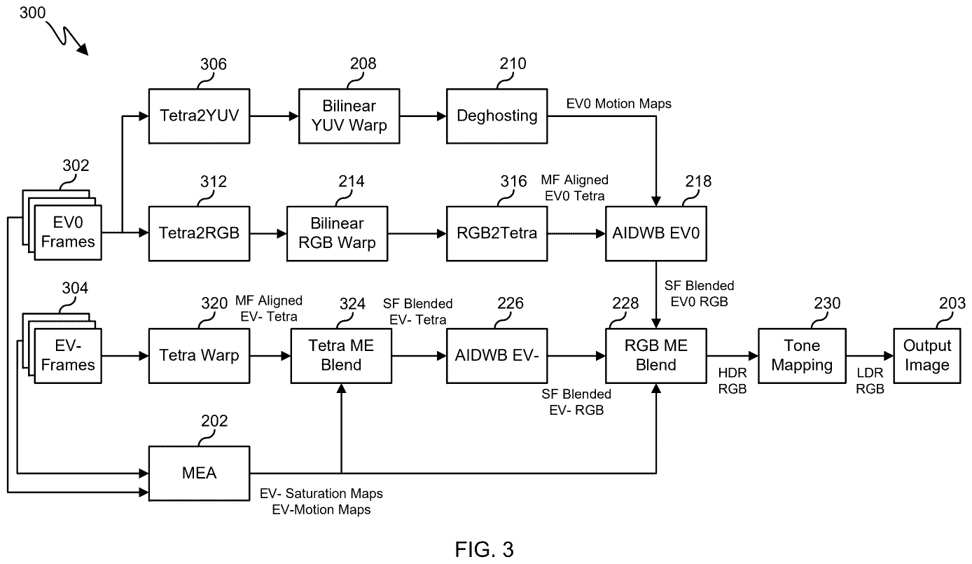

FIG. 3 illustrates another example pipeline 300 for AI-based MFP in accordance with this disclosure. For ease of explanation, the pipeline 300 shown in FIG. 3 may be implemented on or supported by the electronic device 101 in the network configuration 100 of FIG. 1. However, the pipeline 300 shown in FIG. 3 could be used with any other suitable device(s) (such as the server 106) and in any other suitable system(s).

The pipeline 300 is similar to the pipeline 200, except, in this example, the pipeline 300 is configured to operate using Tetra images as its color filter array images, rather than another color filter array format like Bayer images. Thus, operations of the pipeline 300 that deal with sets of input Tetra images (e.g., EV0 frames 302 and EV-frames 304) are shown in FIG. 3. Such operations incldue a Tetra2YUV operation 306 that that converts Tetra images of the EV0 frames to YUV images, a Tetra2RGB operation 312 that converts Tetra images of the EV0 frames to RGB images, an RGB2Tetra operation 316 that takes aligned RGB images provided by operation 214 and outputs multi-frame aligned EV0 Tetra images, a Tetra warp operation 320 that takes Tetra EV-frames 304 and aligns the EV-frames, and a Tetra blending operation 324 that takes the aligned Tetra EV-frames provided by the Tetra warp operation 320 and generates a single-frame EV-Tetra image that is provided to the second artificial intelligence model 226. Like the pipeline 200, the first artificial intelligence model 218 still provides a single-frame blended EV0 RGB image and the second artificial intelligence model 226 still provides a single-frame blended EV-RGB image, which are blended using operation 228. This disclosure thus provides two types of networks for AI MFP training: EV0 multi-frame network training (e.g., for the first artificial intelligence model 218) and EV-single frame network training (e.g., the second artificial intelligence model 226, which can be configured to work with one more color filter array format, as described above).

Although FIG. 3 illustrates one example of a pipeline 300 for AI-based MFP, various changes may be made to FIG. 3. For example, various components or operations in FIG. 3 may be combined, further subdivided, replicated, rearranged, or omitted according to particular needs. Also, various additional components or operations may be used in FIG. 3. Further, the pipeline 300 may be used to process any number of sets of input image frames 202, 204 in order to generate any number of output images 203. In addition, the specific pipeline 300 described above is for illustration and explanation only. Various image processing pipelines and other pipelines have been developed, and additional pipelines are sure to be developed in the future. This disclosure is not limited to any specific implementation of an image processing pipeline. In general, the techniques for AI-based MFP that are described in this patent document may be used in any other image processing pipeline or other architecture.

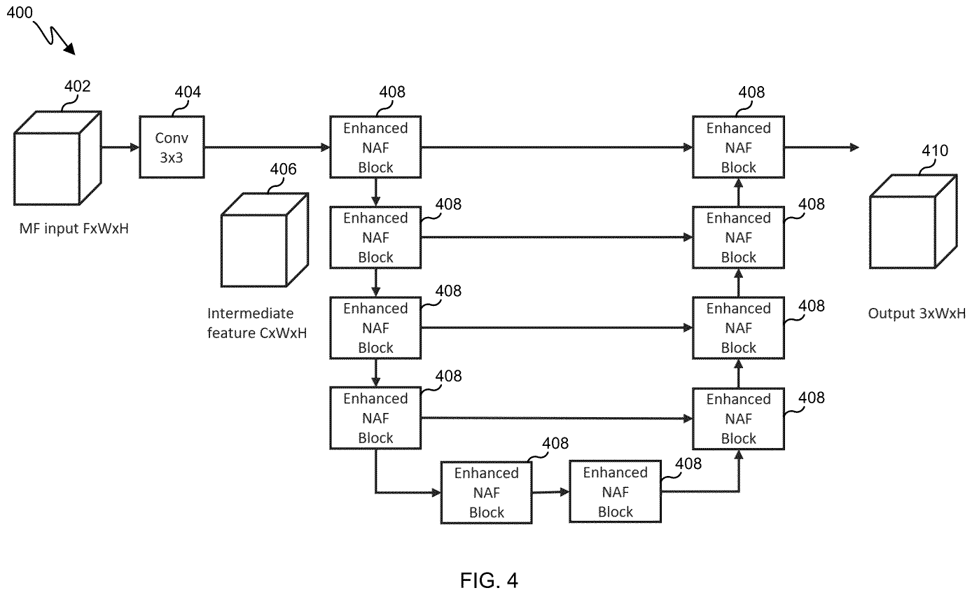

The first artificial intelligence model 218 may include any suitable machine learning-based architecture that can be trained to combine image frames, such as a convolution neural network (CNN) or other deep learning neural network. For example, FIG. 4 illustrates an example artificial intelligence model architecture 400 in accordance with this disclosure. For ease of explanation, the architecture 400 shown in FIG. 4 is described as being implemented on or supported by the electronic device 101 in the network configuration 100 of FIG. 1. However, the architecture 400 shown in FIG. 4 could be used with any other suitable device(s) and in any other suitable system(s).

The architecture 400 can be used for the first artificial intelligence model 218 described with respect to FIG. 2. Existing models have used simplified channel attention, but the architecture 400 replaces simplified channel attention with convolution layers. This avoids tiling artifacts. For instance, as shown in FIG. 4, the architecture 400 is based on a U-net architecture, but, here, uses multi-frame input fusion where a multi-frame input 402 (of dimensions F×W×H) is provided to a convolution layer 404 to create an intermediate feature map 406 (of dimensions C×W×H), which is processed by a plurality of enhanced non-linear activation free (NAF) blocks 408 to provide an output 410 (of dimensions 3×W×H). The output 410 can be the single-frame blended EV0 RGB image provided by the first artificial intelligence model 218 as described with respect to FIG. 2. The architecture 400 provides for improved layer normalization parameterization compared to existing models.

Although FIG. 4 illustrates one example of an artificial intelligence model architecture 400, various changes may be made to FIG. 4. For example, various components and functions in FIG. 4 may be combined, further subdivided, replicated, or rearranged according to particular needs. Also, one or more additional components and functions may be included if needed or desired.

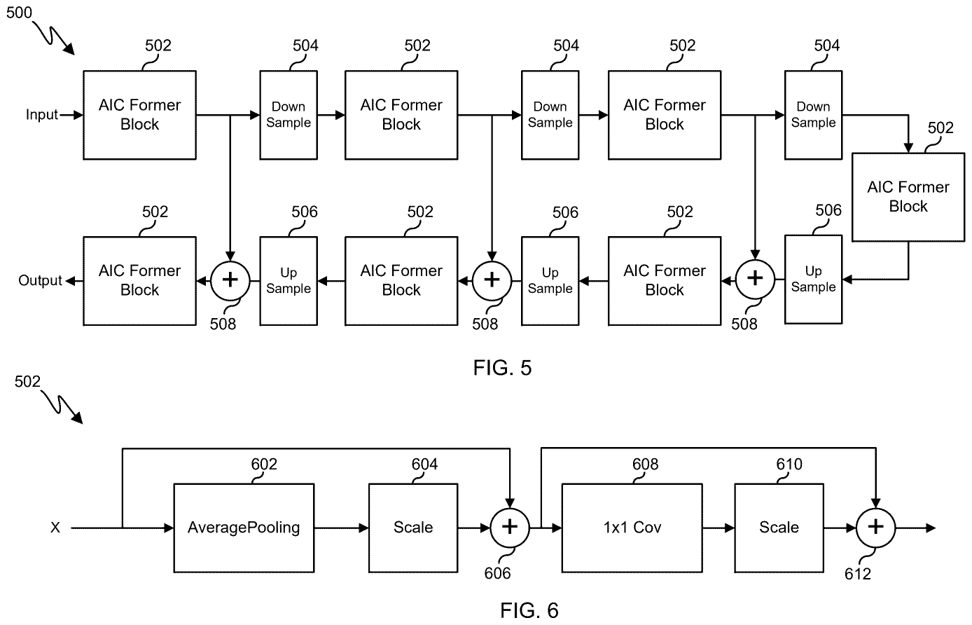

The second artificial intelligence model 226 may include any suitable machine learning-based architecture that can be trained to create single-frame RGB images from single-frame color filter array images. For example, FIG. 5 illustrates an example artificial intelligence model architecture 500 in accordance with this disclosure. For ease of explanation, the architecture 500 shown in FIG. 5 is described as being implemented on or supported by the electronic device 101 in the network configuration 100 of FIG. 1. However, the architecture 500 shown in FIG. 5 could be used with any other suitable device(s) and in any other suitable system(s).

The architecture 500 can be used for the second artificial intelligence model 226 described with respect to FIG. 2. As shown in FIG. 5, the architecture 500 can be a semantic flow network that includes a plurality of AI center (AIC) former blocks 502. A first one of the AIC former blocks receives an input, such as the single-frame EV-color filter array image described with respect to FIG. 2, and outputs to a downsampling operation 504. Multiple AIC former blocks 502 and downsampling operations 504 are performed until the input is downsampled to a particular degree. Then, upsampling operations 506 are performed in between AIC former blocks 502, as shown in FIG. 5. Additionally, during the upsampling portion of the architecture 500, as shown in FIG. 5, each upsampling operation 506 is followed by a combination operation 508 that combines the output of each upsampling operation 506 with the output from a corresponding one of the AIC former blocks 502 from the downsampling portion of the architecture 500. As shown in FIG. 5, once the end of the upsampling portion of the architecture 500 is reached, the final AIC former block 502 provides an output, which can be the single-frame blended EV-RGB image described with respect to FIG. 2.

FIG. 6 illustrates an example AIC former block 502 in accordance with this disclosure. As shown in FIG. 6, each AIC former block 502 receives an input (x) which is processed by an average pooling operation 602 and then scaled using a scaling operation 604. The output of the scaling operation 604 and the original input (x) are combined at a combination operation 606. The result of the combination operation 606 is provided to a convolution operation 608 (e.g., a 1×1 convolution operation). The output of the convolution operation 608 is provided to another scaling operation 610. The scaling operations 604 and 610 can be learnable parameters taught during training. The result of the scaling operation 610 is provided to a combination operation 612, which combines the result of the scaling operation 610 with the result of the previous combination operation 606. This generates an output that is provided to a next layer of the architecture 500, e.g., one of the downsampling operation 504 or the upsampling operation 506.

Although FIG. 5 illustrates one example of an artificial intelligence model architecture 500, and FIG. 6 illustrates an example AIC former block 502, various changes may be made to FIGS. 5 and/or 6. For example, various components and functions in FIGS. 5 and/or may be combined, further subdivided, replicated, or rearranged according to particular needs. Also, one or more additional components and functions may be included if needed or desired.

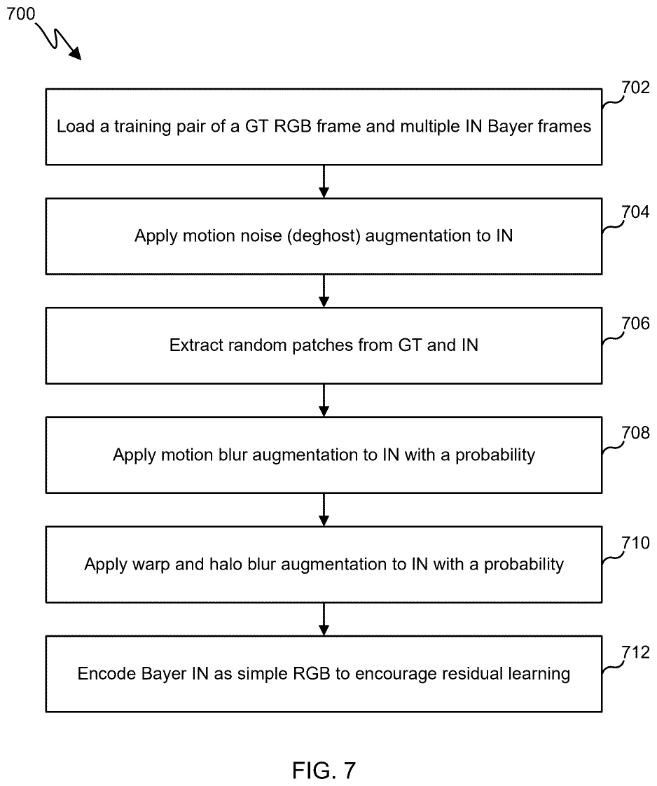

FIG. 7 illustrates an example method 700 for multi-frame AI training in accordance with this disclosure. For ease of explanation, the method 700 shown in FIG. 7 is described as being performed using the electronic device 101 in the network configuration 100 of FIG. 1. However, the method 700 could be performed using any other suitable device(s), such as the server 106, and in any other suitable system(s).

The method 700 can be used to train an AI model that processes multi-frame EV0 images, such as the first artificial intelligence model 218 of FIG. 2. At step 702, a ground truth (GT) RGB image frame and multiple input (IN) Bayer image frames are obtained, although it will be understood that other color filter array formats can be used, such as the Tetra format. At step 704, motion noise is augmented into the IN Bayer image frames. At step 706, random patches are extracted from the GT and IN Bayer image frames, after which motion blur augmentation is applied (at step 708) to the IN Bayer image frames with some probability. At step 710, warp and halo blur augmentation are applied to the IN Bayer image frames with some probability. At step 712, the IN Bayer image frames are encoded as simple RGB to encourage residual learning.

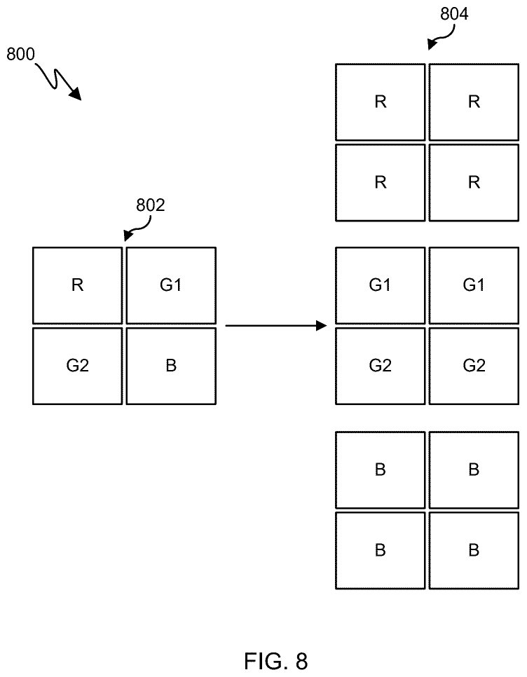

FIG. 8 illustrates an example RGB encoding process 800 is performed in accordance with this disclosure. For ease of explanation, the process 800 is described as involving the use of the electronic device 101 in the network configuration 100 of FIG. 1. However, the process 800 may be used with any other suitable electronic device (such as the server 106) or a combination of devices (such as the electronic device 101 and the server 106) and in any other suitable system(s).

The process 800 can be performed during step 712 of FIG. 7. As shown in FIG. 8, a Bayer frame 802, which consists of a mosaic of red, green, and blue filters arranged in a specific pattern (e.g., RGGB in this case), is converted to an RGB image 804 that includes a plurality of RGB information.

Although FIG. 7 illustrates one example of a method 700 for multi-frame AI training, and FIG. 8 illustrates an example RGB encoding process 800, various changes may be made to FIGS. 7 and 8. For example, while shown as a series of steps, various steps in FIGS. 7 and 8 could overlap, occur in parallel, occur in a different order, or occur any number of times (including zero times).

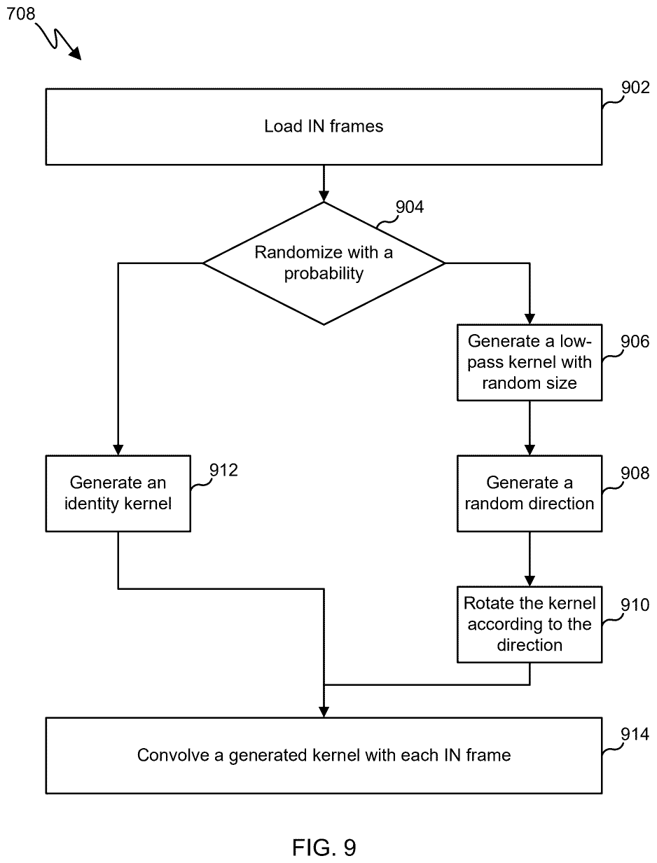

FIG. 9 illustrates an example method 900 for applying motion blur augmentation in accordance with this disclosure. For ease of explanation, the method 900 shown in FIG. 9 is described as being performed using the electronic device 101 in the network configuration 100 of FIG. 1. However, the method 900 could be performed using any other suitable device(s), such as the server 106, and in any other suitable system(s).

As discussed above, step 708 of FIG. 7 includes applying motion blur augmentation to the IN Bayer image frames. The method 900 can thus be used to perform step 708. As shown in FIG. 9, the method 900 includes, at step 902, obtaining input (IN) frames. At step 904, a binary decision is randomized with some probability. At step 906, a low-pass blur kernel of a random size is generated. A random blur direction is chosen at step 908, and the low-pass blur kernel is rotated at step 910 according to the chosen direction.

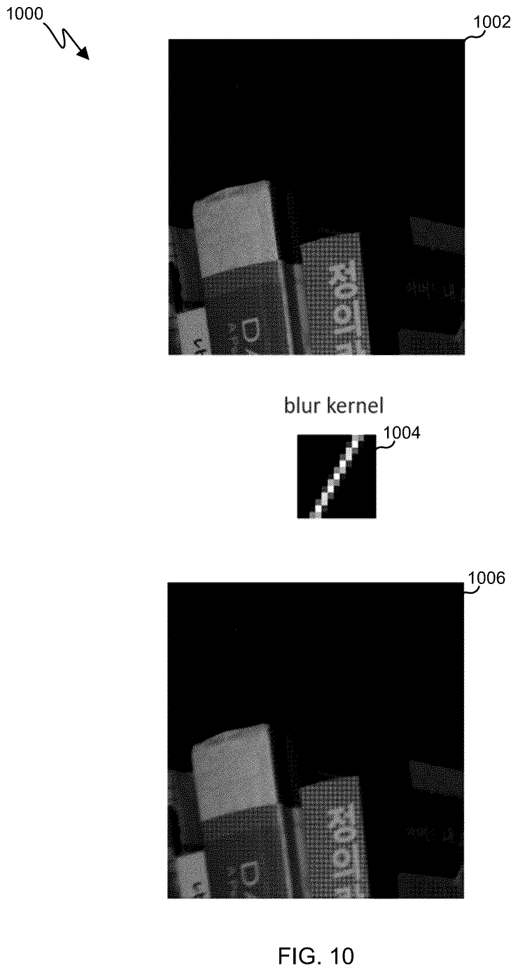

FIG. 10 illustrates an example application 1000 of motion blur augmentation in accordance with this disclosure. FIG. 10 shows an example result 1004 of step 910. At step 912, an identity kernel is also generated based on the randomized IN frames. Each IN frame is convolved with a generated kernel at step 914. For example, as shown in FIG. 10, a IN frame 1002 is subjected to motion blur augmentation using a blur kernel (identify kernel or low-pass kernel) to provide an output frame 1006 that includes synthetic motion blur.

Although FIG. 9 illustrates one example of a method 900 for applying motion blur augmentation, and FIG. 10 illustrates one example application 1000 of motion blur augmentation, various changes may be made to FIGS. 9 and 10. For example, while shown as a series of steps, various steps in FIGS. 9 and 10 could overlap, occur in parallel, occur in a different order, or occur any number of times (including zero times).

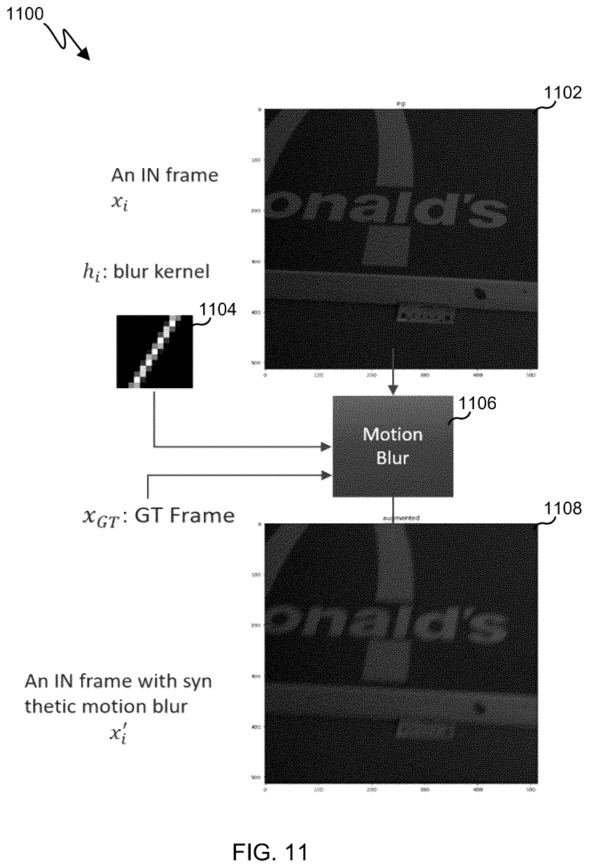

In various embodiments, GT-based blur can also be used to augment IN frames with motion blur. For instance, FIG. 11 illustrates an example process 1100 for motion blur augmentation with GT-based blur in accordance with this disclosure. In the process 1100, the motion augmentation is applied to some of the frames (e.g., IN frame 1102) using random motion blur kernels 1104. A motion blur augmentation operation 1106 takes the blur kernels 1104 as well as GT frames as inputs to apply synthetic motion blur to the IN frame 1102 to generate an output IN frame 1108 that includes the synthetic motion blur. In various embodiments, each of the blurred frames may have a different random blur kernel hi of a different size. This process can be represented as follows.

$${n}_{i} = {x}_{i} - {a}_{i} {x}_{GT}$$

$${x}_{i}^{′} = {h}_{i} * ( {x}_{i} - {n}_{i} ) + {n}_{i}$$

$$i = 1 , 2 , 3 , ... , {N}_{frames}$$

Here, aᵢ ∈ [symbol] is chosen to match the brightness level of x_{GT}, xᵢ is the original frame

$${x}_{i}^{′}$$

is the blurred frame, and nᵢ is the noise of the original frame.

This process generally includes: (1) estimating the noise using the ground truth frame, (2) removing the estimated noise from the given image frame; (3) performing the blurring operation on the noise-compensated image frame; and (4) adding the estimated noise to the result of the blurring operation. This step is important since the night capture frames suffer from significant noise. The blurring can also be applied to each of the Bayer channels individually to preserve the color filter pattern.

Although FIG. 11 illustrates one example of a process 1100 for motion blur augmentation with GT-based blur, various changes may be made to FIG. 11. For example, while shown as a series of steps, various steps in FIG. 11 could overlap, occur in parallel, occur in a different order, or occur any number of times (including zero times).

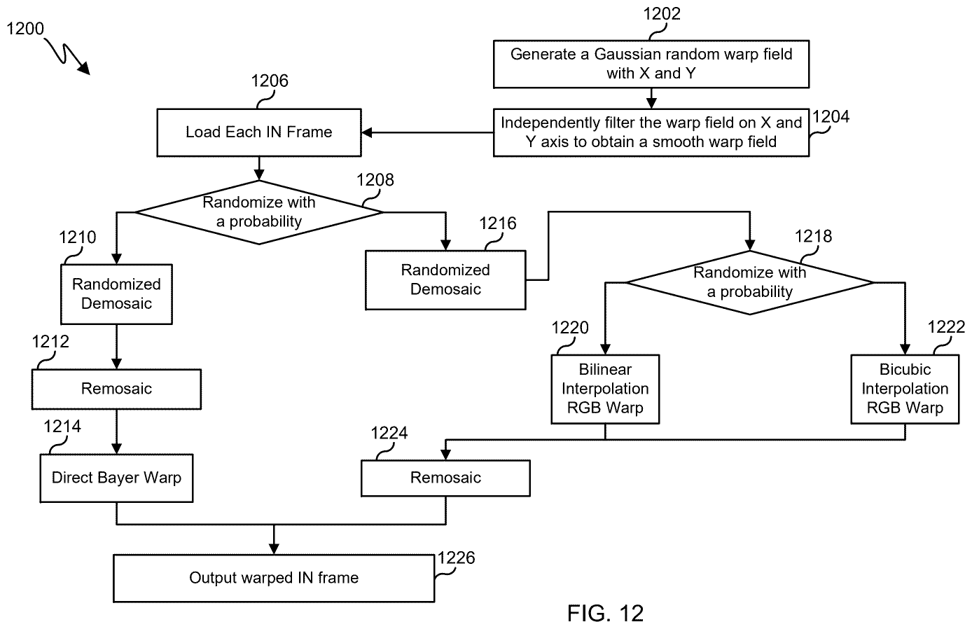

FIG. 12 illustrates an example method 1200 for applying warp augmentation in accordance with this disclosure. For ease of explanation, the method 1200 shown in FIG. 12 is described as being performed using the electronic device 101 in the network configuration 100 of FIG. 1. However, the method 1200 could be performed using any other suitable device(s), such as the server 106, and in any other suitable system(s).

As discussed above, step 710 of FIG. 7 includes applying warp augmentation to the IN Bayer image frames. The method 1200 can thus be used as part of performing step 710. As shown in FIG. 12, the method 1200 includes, at step 1202, a Gaussian random warp field (with X and Y axes) is generated. The warp field is then independently filtered on both axes at step 1204 to obtain a smooth warp field. At step 1206, each IN frame is obtained and a binary decision is randomized with some probability at step 1208. At step 1210, randomized demosaicing is performed, followed by remosaicing at step 1212.

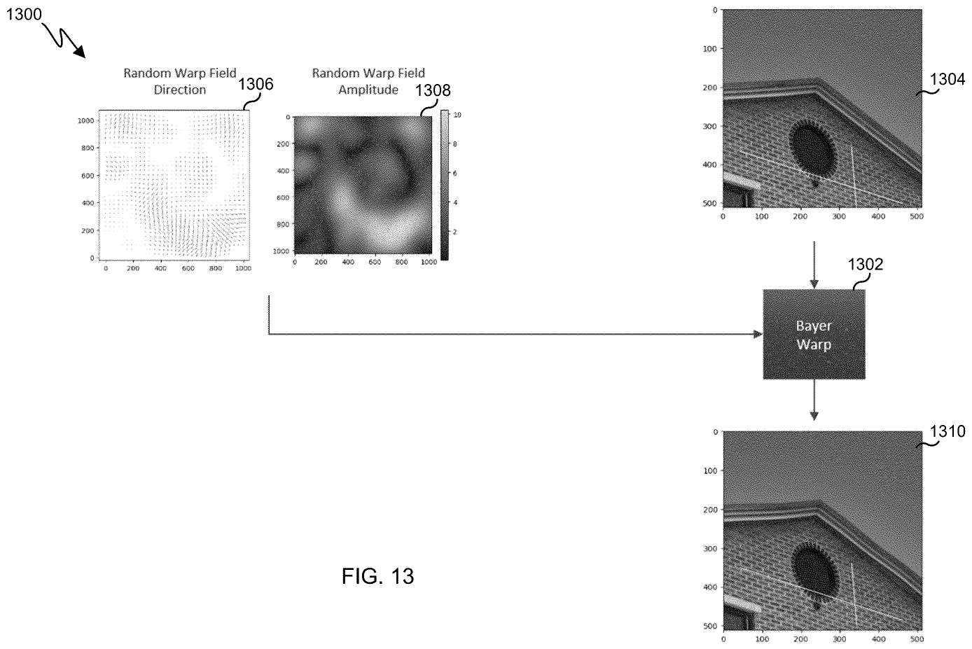

At step 1214, a direct Bayer warp operation is subsequently performed on the output of the remosaicing operation that was performed at step 1212. For instance, FIG. 13 illustrates an example process 1300 for a direct Bayer warp operation in accordance with this disclosure. For ease of explanation, the process 1300 shown in FIG. 13 is described as being performed using the electronic device 101 in the network configuration 100 of FIG. 1. However, the process 1300 could be performed using any other suitable device(s), such as the server 106, and in any other suitable system(s).

As noted above, the process 1300 is an example of a direct Bayer warp operation such as performed at step 1214 of FIG. 12. As shown in FIG. 13, a Bayer warp operation 1302 is applied to some of the frames (e.g., frame 1304) where each of the warped frames is generated using a different random warp field having a random warp field direction 1306 and a random warp field amplitude 1308. The warp can be applied to Bayer images using any Bayer specific warping method to generate an output 1310. The warping dispersions at each pixel may be different but substantially locally correlated. Parameters such as locality of and overall strength may be adjusted to maximize image quality (IQ).

As further illustrated in FIG. 12, the method also includes, at step 1216, performing another randomized demosaicing operation followed by a random binary decision at step 1218 that chooses between performing a bilinear interpolation warp operation at step 1220 or performing a bicubic RGB warp operation at step 1222. Then, at step, 1224, a remosaicing operation is performed. At step 1226, the warped IN frame is then output.

Although FIG. 12 illustrates one example of a method 1200 for applying warp augmentation, and FIG. 13 illustrates one example of a process 1300 for a direct Bayer warp operation, various changes may be made to FIGS. 12 and/or 13. For example, while shown as a series of steps, various steps in FIGS. 12 and/or 13 could overlap, occur in parallel, occur in a different order, or occur any number of times (including zero times).

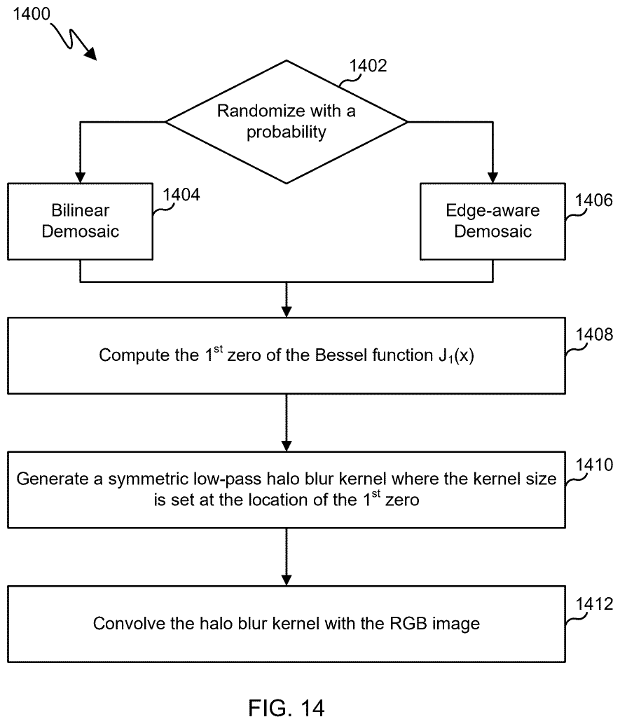

FIG. 14 illustrates an example method 1400 for applying halo blur augmentation in accordance with this disclosure. For ease of explanation, the method 1400 shown in FIG. 14 is described as being performed using the electronic device 101 in the network configuration 100 of FIG. 1. However, the method 1400 could be performed using any other suitable device(s), such as the server 106, and in any other suitable system(s).

As discussed above, step 710 of FIG. 7 includes applying halo blur augmentation to the IN Bayer image frames. The method 1400 can thus be used as part of performing step 710. As shown in FIG. 14, the method 1400 includes, at step 1402, a binary decision that is randomized with some probability. Depending on the binary decision at step 1402, either a bilinear demosaic operation can be performed at step 1404 or an edge-aware demosaic operation can be performed at step 1406.

At step 1408, a first zero of the Bessel function J₁(x) is computed. Then, at step 1410, a symmetric low-pass halo blur kernel is generated, where the kernel size is set at the location of the first zero of the Bessel function. This can be represented as follows.

$$h [ {n}_{1} , {n}_{2} ] = \frac{{w}_{c}}{2 π \sqrt{{n}_{1}^{2} + {n}_{2}^{2}}} {J}_{1} ( {w}_{c} \sqrt{{n}_{1}^{2} + {n}_{2}^{2}} )$$

At step 1412, the halo blur kernel is convolved with the RGB image to generated an image including synthetic halo blur.

Although FIG. 14 illustrates one example of a method 1400 for applying halo blur augmentation, various changes may be made to FIG. 14. For example, while shown as a series of steps, various steps in FIG. 14 could overlap, occur in parallel, occur in a different order, or occur any number of times (including zero times).

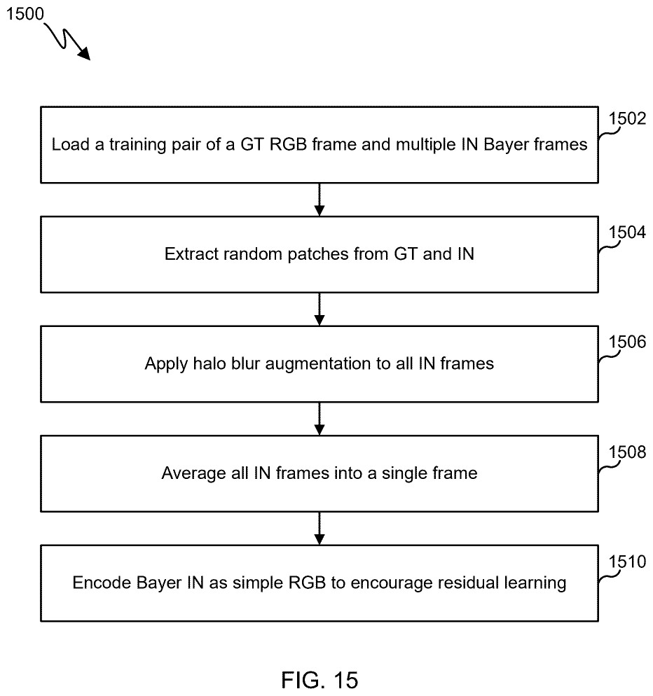

FIG. 15 illustrates an example method 1500 for single-frame AI training in accordance with this disclosure. For ease of explanation, the method 1500 shown in FIG. 15 is described as being performed using the electronic device 101 in the network configuration 100 of FIG. 1. However, the method 1500 could be performed using any other suitable device(s), such as the server 106, and in any other suitable system(s).

The method 1500 can be used to train an AI model that processes single-frame EV-images, such as the second artificial intelligence model 226 of FIG. 2. At step 1502, a ground truth (GT) RGB image frame and multiple input (IN) Bayer image frames are obtained. At step 1504, random patches are extracted from the GT and IN Bayer image frames, after which halo blur augmentation is applied at step 1506 to all the IN Bayer image frames. The halo blur augmentation can be performed similar to that described with respect to FIG. 14. At step 1508, all IN frames are averaged into a single IN frame. At step 1510, the single IN Bayer image frame is encoded as an RGB image to encourage residual learning.

Although FIG. 15 illustrates one example of a method 1500 for single-frame AI training, various changes may be made to FIG. 15. For example, while shown as a series of steps, various steps in FIG. 15 could overlap, occur in parallel, occur in a different order, or occur any number of times (including zero times).

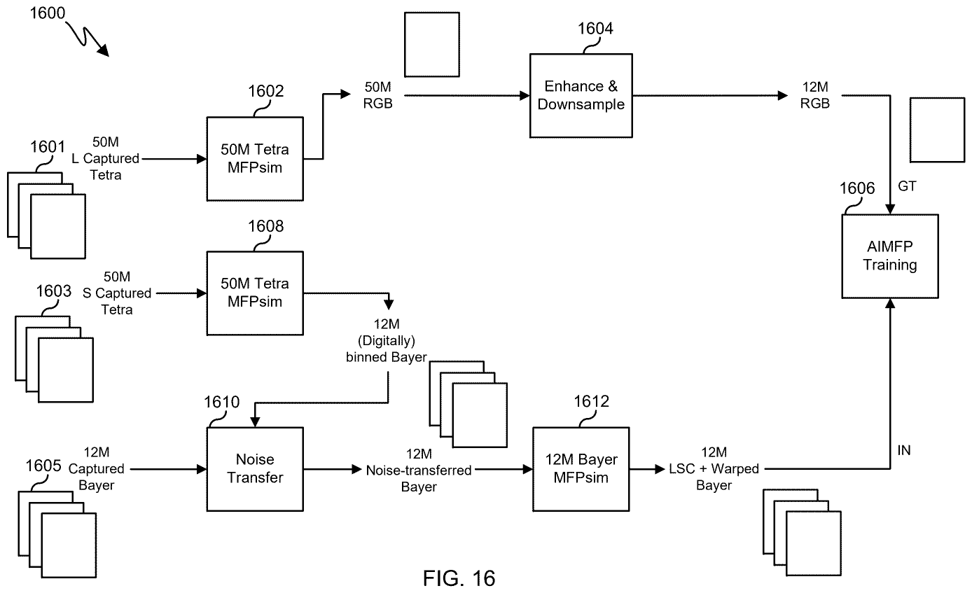

FIG. 16 illustrates an example process 1600 for generating training data in accordance with this disclosure. For ease of explanation, the process 1600 is described as involving the use of the electronic device 101 in the network configuration 100 of FIG. 1. However, the process 1600 may be used with any other suitable electronic device (such as the server 106) or a combination of devices (such as the electronic device 101 and the server 106) and in any other suitable system(s).

The AI model training methods discussed in this disclosure use GT and IN frames. The process 1600 can be used for generating high-resolution (HR)-based ground truth (GT) and input (IN) training data. In various embodiments of this disclosure, 50 megapixel (MP) and HR are used interchangeably. Similarly, 12 MP and low-resolution (LR) are also used interchangeably. Long (L) and short(S) frames are frames captured with long and short exposure time, respectively, which are both captured at the default exposure value, i.e. EV0. Frames captured at lower exposure values are explicitly denoted as EV-, e.g. EV-2, EV-4, EV-6.

As shown in FIG. 16, HR (50M) multi-frame data with long and short exposure time are captured of static scenes. The data format in this example is Tetra for HR. Low-resolution (LR) 12M multi-frame data with short exposure time can also be captured of the same static scenes. At operation 1602, a 50M Tetra MFP simulator can be used to jointly combine and demosaic the multi-frame long exposure-time data 1601 into a single HR/50M RGB image that serves as an initial ground truth (GT) for a scene. A further enhancement and downsampling of the GT can be performed in operation 1604 to generate 12M/LR RGB image, which serves as the final GT to, for example, AI MFP training network 1606. The downsampling can be performed using pixel area relation methods, as one example.

At operation 1608, the 50M Tetra MFP simulator can also be used to digitally bin HR Tetra frames with short exposure-time 1603 into LR Bayer frames. The operation 1608 can include the averaging of Tetra pixels of the same color, i.e.

$$pBayer = 0.25 {\sum }_{i = 1}^{4} pTetra , i ,$$

### p ∈ {R, G, B}.

Operation 1610 is a noise transfer operation that can be used to transfer the physical analog noise from the captured LR/12M Bayer frames 1605 to the digitally binned LR Bayer frames. The output of the noise transfer operation 1610 are LR Bayer frames with analog noise that is aligned with the GT. In various embodiments, operation 1610 can be implemented as follows. Assume an AIMFP model has been trained with 12M binned Bayer IN and 12M RGB GT, i.e. the result of an initial AIMFP training 1606. This model can then be used to process 12M captured Bayer long exposure frames to generate new GT for the 12M captured Bayer short exposure frames. Then operation 1606 can be repeated for this new GT and IN pairs, effectively learning the noise characteristics of 12M captured Bayer frames, and thus transferring the noise characteristics in the process.

As also shown in FIG. 16, an operation 1612 is a LR/12M Bayer MFP simulator that applies basic pre-processing like lens-shading correction (LSC) and aligns the input LR Bayer frames to generate LR LSC and/or aligned Bayer frames. There are several alignment options: 1) no alignment (i.e. just LSC), 2) direct Bayer alignment, and 3) bilinear alignment in RGB domain, with GBTF-based demosaic and remosaic for Bayer to RGB domain conversion, respectively.

Operations such as operation 1602 where multiple Tetra images are blended (and demosaiced) to obtain a single 50 M RGB image can be found in U.S. Patent Application Publication No. 2024/0221130, which is incorporated by reference herein. Operations similar to operation 1612, e.g., lens shading correction and Bayer warping, can be found at https://www.mathworks.com/help/vision/ref/undistortimage.html and U.S. Patent Application Publication No. 2023/0035482,” which are both incorporated by reference herein. Operations similar to operation 1604, e.g., image enhancement and downsampling, can be found in 1) Restormer (https://arxiv.org/abs/2111.09881), and 2) BSRGAN (https://github.com/cszn/BSRGAN), which are both incorporated by reference herein.

Although FIG. 16 illustrates one example of a process 1600 for generating training data, various changes may be made to FIG. 16. For example, while shown as a series of steps, various steps in FIG. 16 could overlap, occur in parallel, occur in a different order, or occur any number of times (including zero times).

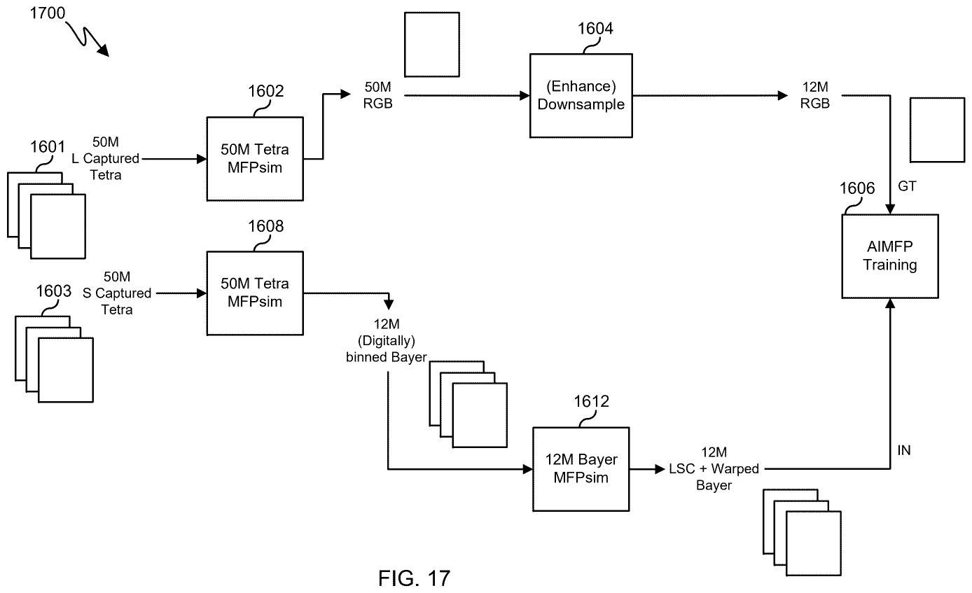

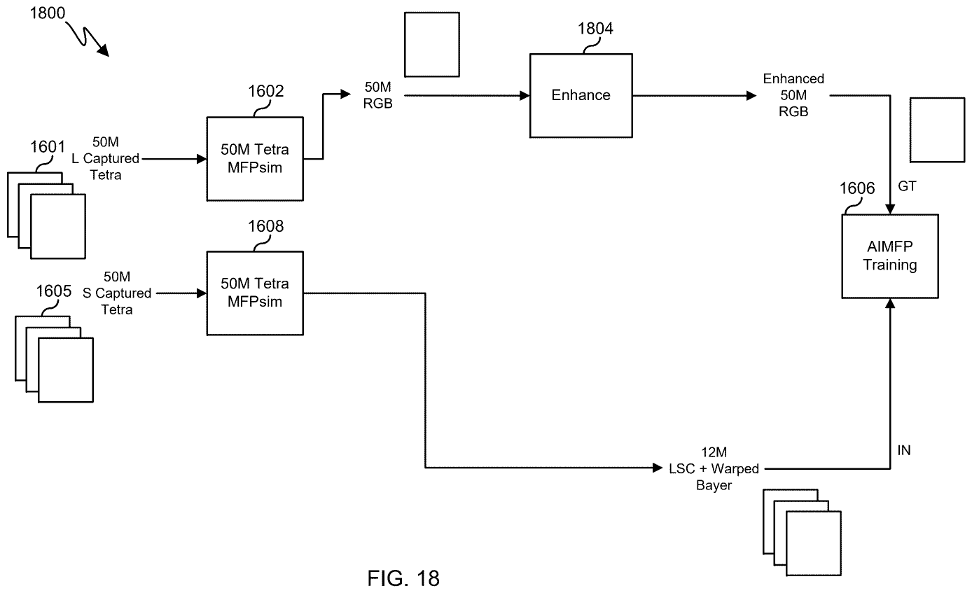

FIG. 17 illustrates another example process 1700 for generating training data in accordance with this disclosure. For ease of explanation, the process 1700 is described as involving the use of the electronic device 101 in the network configuration 100 of FIG. 1. However, the process 1700 may be used with any other suitable electronic device (such as the server 106) or a combination of devices (such as the electronic device 101 and the server 106) and in any other suitable system(s).

FIG. 17 shows an example alternative process for HR-based GT and IN training data generation. In comparison to the process 1600 in FIG. 16, the process in FIG. 17 bypasses noise transferring, resulting in a simpler training data generation pipeline. Particularly, while the process 1700 still performs operations 1602, 1604, 1606, 1608, and 1612, operation 1610 shown in FIG. 16 is not performed, and thus the 12M captured Bayer images 1605 are also not used in the process 1700.

Although FIG. 17 illustrates one example of a process 1700 for generating training data, various changes may be made to FIG. 17. For example, while shown as a series of steps, various steps in FIG. 17 could overlap, occur in parallel, occur in a different order, or occur any number of times (including zero times).

FIG. 18 illustrates another example process 1800 for generating training data in accordance with this disclosure. For ease of explanation, the process 1800 is described as involving the use of the electronic device 101 in the network configuration 100 of FIG. 1. However, the process 1800 may be used with any other suitable electronic device (such as the server 106) or a combination of devices (such as the electronic device 101 and the server 106) and in any other suitable system(s).

FIG. 18 shows an example alternative process for HR-based GT and IN training data generation. In comparison to the process 1600 in FIG. 16, like the process 1700, the process in FIG. 18 also bypasses noise transferring, resulting in a simpler training data generation pipeline. Also, in the example of process 1800, training data is generated to train an HR/50M Tetra AIMFP network. Hence, the operation 1604 is replaced by operation 1804 that takes as input the HR RGB image and generates an enhanced version of the same. The enhanced HR RGB image serves as the GT into the AI MFP training network. Additionally, operation 1612 is also not performed in the process 1800. Thus, the HR/50M Tetra MFP simulator operations (1602, 1604) can be used to apply pre-processing like LSC and warp the HR Tetra frames with short exposure time 1605 to generate aligned version of the same. There are several alignment options: 1) no alignment (i.e. just LSC), and 2) bilinear alignment in RGB domain, with bilinear demosaic and remosaic for Tetra to RGB domain conversion, respectively. These LSC and aligned HR Tetra frames serve as IN into the AI MFP training network.

Although FIG. 17 illustrates one example of a process 1700 for generating training data, various changes may be made to FIG. 17. For example, while shown as a series of steps, various steps in FIG. 17 could overlap, occur in parallel, occur in a different order, or occur any number of times (including zero times).

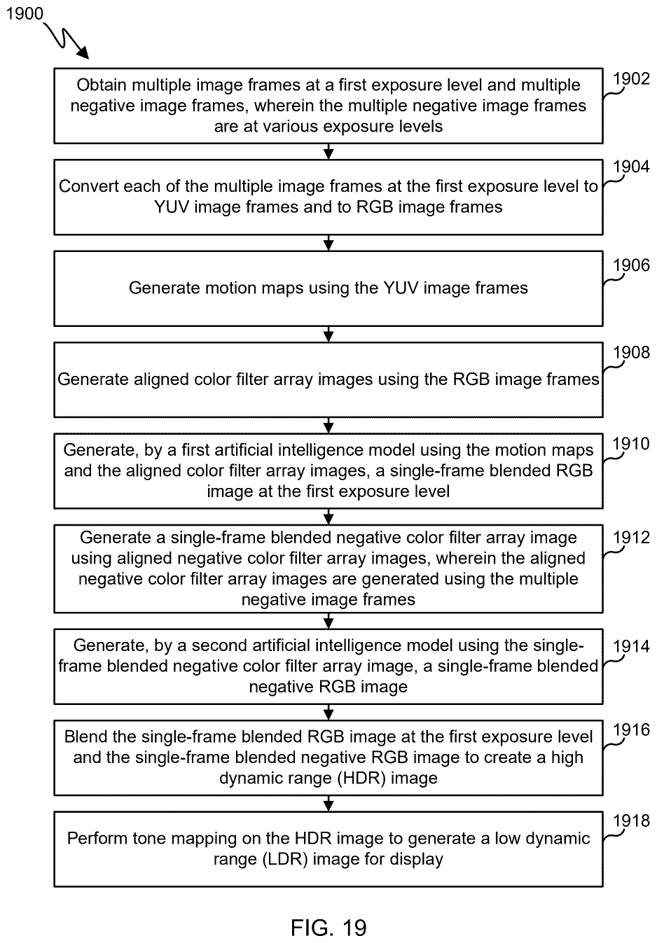

FIG. 19 illustrates an example AI-based MFP method 1900 in accordance with this disclosure. For ease of explanation, the method 1900 shown in FIG. 19 is described as being performed using the electronic device 101 in the network configuration 100 of FIG. 1. However, the method 1900 could be performed using any other suitable device(s), such as the server 106, and in any other suitable system(s).

It will be understood that the method 1900 can be used with the AI-based MFP pipelines of this disclosure, such as the pipelines 200 and 300 described with respect to FIGS. 2 and 3, respectively. At step 1902, multiple image frames at a first exposure level are obtained and multiple negative image frames are obtained, where the multiple negative image frames are at various exposure levels. At step 1904, each of the multiple image frames at the first exposure level is converted to YUV image frames and also to RGB image frames. At step 1906 motion maps are generated using the YUV image frames. At step 1908, aligned color filter array images are generated using the RGB image frames. At step 1910, a single-frame blended RGB image at the first exposure level is generated by a first artificial intelligence model using the motion maps and the aligned color filter array images.

In various embodiments the first artificial intelligence model can be the AI model 218 of FIGS. 2 and 3. As described in this disclosure, in various embodiments, to train the first artificial intelligence model, a training pair can be obtained, where the training pair includes a ground truth RGB frame and input color filter array image frames, motion noise augmentation can be applied to the input color filter array image frames, random patches can be extracted from the ground truth RGB frame and the input color filter array image frames, motion blur augmentation with a first probability can be applied to the input color filter array image frames, warp and halo blur augmentation with a second probability can be applied to the input color filter array image frames, and the input color filter array image frames can be encoded as RGB frames to encourage residual learning.

At step 1912, a single-frame blended negative color filter array image is generated using aligned negative color filter array images, where the aligned negative color filter array images are generated using the multiple negative image frames. As described in this disclosure, in various embodiments, generating the motion maps using the YUV image frames can include aligning the YUV image frames using a first warp operation and generating the motion maps from the aligned YUV image frames, generating the aligned color filter array images using the RGB image frames includes aligning the RGB image frames using a second warp operation and generating the aligned color filter array images from the aligned RGB image frames, and the aligned negative color filter array images are generated from the multiple negative image frames using a third warp operation.

At step 1914, a single-frame blended negative RGB image is generated by a second artificial intelligence model using the single-frame blended negative color filter array image. In various embodiments the first artificial intelligence model can be the AI model 226 of FIGS. 2 and 3. As described in this disclosure, in various embodiments, the aligned color filter array images, the aligned negative color filter array images, and the single-frame blended negative color filter array image can be Bayer images. As described in this disclosure, in various embodiments, the aligned color filter array images, the aligned negative color filter array images, and the single-frame blended negative color filter array image can be Tetra images.

As described in this disclosure, in various embodiments, to train the second artificial intelligence model, a training pair can be obtained, where the training pair includes a ground truth RGB frame and input color filter array image frames, random patches can be extracted from the ground truth RGB frame and the input color filter array image frames, halo blur augmentation can be applied to the input color filter array image frames, the input color filter array image frames can be averaged into a single input color filter array image, and the single input color filter array image can be encoded as an RGB frame to encourage residual learning.

As described in this disclosure, in various embodiments, to train the first and second artificial intelligence models, a ground truth RGB frame and input color filter array image frames can be generated, where the ground truth RGB frame can be generated using a multi-frame processing simulator to jointly combine and demosaic multi-frame long exposure-time data into a single high resolution RGB image, and the input color filter array image frames can be generated using the multi-frame processing simulator to perform lens shading correction and warping on multi-frame short exposure-time data. As described in this disclosure, in various embodiments, the multi-frame processing simulator is further used to digitally bin the multi-frame short exposure-time data into low resolution color filter array image frames.

At step 1916, the single-frame blended RGB image at the first exposure level and the single-frame blended negative RGB image are blended to create a high dynamic range (HDR) image. At step 1918, tone mapping is performed on the HDR image to generate a low dynamic range (LDR) image for display.

Although FIG. 19 illustrates one example of a AI-based MFP method 1900, various changes may be made to FIG. 19. For example, while shown as a series of steps, various steps in FIG. 19 could overlap, occur in parallel, occur in a different order, or occur any number of times (including zero times).

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, multiple image frames at a first exposure level and multiple negative image frames, wherein the multiple negative image frames are at various exposure levels;
converting each of the multiple image frames at the first exposure level to YUV image frames and to RGB image frames;
generating motion maps using the YUV image frames;
generating aligned color filter array images using the RGB image frames;
generating, by a first artificial intelligence model using the motion maps and the aligned color filter array images, a single-frame blended RGB image at the first exposure level;
generating a single-frame blended negative color filter array image using aligned negative color filter array images, wherein the aligned negative color filter array images are generated using the multiple negative image frames;
generating, by a second artificial intelligence model using the single-frame blended negative color filter array image, a single-frame blended negative RGB image;
blending the single-frame blended RGB image at the first exposure level and the single-frame blended negative RGB image to create a high dynamic range (HDR) image; and
performing tone mapping on the HDR image to generate a low dynamic range (LDR) image for display.

2. The method of claim 1, wherein:
generating the motion maps using the YUV image frames includes aligning the YUV image frames using a first warp operation and generating the motion maps from the aligned YUV image frames;
generating the aligned color filter array images using the RGB image frames includes aligning the RGB image frames using a second warp operation and generating the aligned color filter array images from the aligned RGB image frames; and
the aligned negative color filter array images are generated from the multiple negative image frames using a third warp operation.

3. The method of claim 1, wherein the aligned color filter array images, the aligned negative color filter array images, and the single-frame blended negative color filter array image are Bayer images.

4. The method of claim 1, wherein the aligned color filter array images, the aligned negative color filter array images, and the single-frame blended negative color filter array image are Tetra images.

5. The method of claim 1, wherein, to train the first artificial intelligence model:
a training pair is obtained, wherein the training pair includes a ground truth RGB frame and input color filter array image frames;
motion noise augmentation is applied to the input color filter array image frames;
random patches are extracted from the ground truth RGB frame and the input color filter array image frames;
motion blur augmentation with a first probability is applied to the input color filter array image frames;
warp and halo blur augmentation with a second probability is applied to the input color filter array image frames; and
the input color filter array image frames are encoded as RGB frames to encourage residual learning.

6. The method of claim 1, wherein, to train the second artificial intelligence model:
a training pair is obtained, wherein the training pair includes a ground truth RGB frame and input color filter array image frames;
random patches are extracted from the ground truth RGB frame and the input color filter array image frames;
halo blur augmentation is applied to the input color filter array image frames;
the input color filter array image frames are averaged into a single input color filter array image; and
the single input color filter array image is encoded as an RGB frame to encourage residual learning.

7. The method of claim 1, wherein, to train the first and second artificial intelligence models, a ground truth RGB frame and input color filter array image frames are generated,
wherein the ground truth RGB frame is generated using a multi-frame processing simulator to jointly combine and demosaic multi-frame long exposure-time data into a single high resolution RGB image, and
wherein the input color filter array image frames are generated using the multi-frame processing simulator to perform lens shading correction and warping on multi-frame short exposure-time data.

8. The method of claim 7, wherein the multi-frame processing simulator is further used to digitally bin the multi-frame short exposure-time data into low resolution color filter array image frames.

9. An electronic device comprising:
at least one processing device configured to:
obtain multiple image frames at a first exposure level and multiple negative image frames, wherein the multiple negative image frames are at various exposure levels;
convert each of the multiple image frames at the first exposure level to YUV image frames and to RGB image frames;
generate motion maps using the YUV image frames;
generate aligned color filter array images using the RGB image frames;
generate, by a first artificial intelligence model using the motion maps and the aligned color filter array images, a single-frame blended RGB image at the first exposure level;
generate a single-frame blended negative color filter array image using aligned negative color filter array images, wherein the aligned negative color filter array images are generated using the multiple negative image frames;
generate, by a second artificial intelligence model using the single-frame blended negative color filter array image, a single-frame blended negative RGB image;
blend the single-frame blended RGB image at the first exposure level and the single-frame blended negative RGB image to create a high dynamic range (HDR) image; and
perform tone mapping on the HDR image to generate a low dynamic range (LDR) image for display.

10. The electronic device of claim 9, wherein:
to generate the motion maps using the YUV image frames, the at least one processing device is configured to align the YUV image frames using a first warp operation and generate the motion maps from the aligned YUV image frames;
to generate the aligned color filter array images using the RGB image frames, the at least one processing device is configured to align the RGB image frames using a second warp operation and generate the aligned color filter array images from the aligned RGB image frames; and
the aligned negative color filter array images are generated from the multiple negative image frames using a third warp operation.

11. The electronic device of claim 9, wherein the aligned color filter array images, the aligned negative color filter array images, and the single-frame blended negative color filter array image are Bayer images.

12. The electronic device of claim 9, wherein the aligned color filter array images, the aligned negative color filter array images, and the single-frame blended negative color filter array image are Tetra images.

13. The electronic device of claim 9, wherein, to train the first artificial intelligence model:
a training pair is obtained, wherein the training pair includes a ground truth RGB frame and input color filter array image frames;
motion noise augmentation is applied to the input color filter array image frames;
random patches are extracted from the ground truth RGB frame and the input color filter array image frames;
motion blur augmentation with a first probability is applied to the input color filter array image frames;
warp and halo blur augmentation with a second probability is applied to the input color filter array image frames; and
the input color filter array image frames are encoded as RGB frames to encourage residual learning.

14. The electronic device of claim 9, wherein, to train the second artificial intelligence model:
a training pair is obtained, wherein the training pair includes a ground truth RGB frame and input color filter array image frames;
random patches are extracted from the ground truth RGB frame and the input color filter array image frames;
halo blur augmentation is applied to the input color filter array image frames;
the input color filter array image frames are averaged into a single input color filter array image; and
the single input color filter array image is encoded as an RGB frame to encourage residual learning.

15. The electronic device of claim 9, wherein, to train the first and second artificial intelligence models, a ground truth RGB frame and input color filter array image frames are generated,
wherein the ground truth RGB frame is generated using a multi-frame processing simulator to jointly combine and demosaic multi-frame long exposure-time data into a single high resolution RGB image, and
wherein the input color filter array image frames are generated using the multi-frame processing simulator to perform lens shading correction and warping on multi-frame short exposure-time data.

16. The electronic device of claim 15, wherein the multi-frame processing simulator is further used to digitally bin the multi-frame short exposure-time data into low resolution color filter array image frames.

17. A non-transitory machine readable medium comprising instructions that when executed cause at least one processor of an electronic device to:
obtain multiple image frames at a first exposure level and multiple negative image frames, wherein the multiple negative image frames are at various exposure levels;
convert each of the multiple image frames at the first exposure level to YUV image frames and to RGB image frames;
generate motion maps using the YUV image frames;
generate aligned color filter array images using the RGB image frames;
generate, by a first artificial intelligence model using the motion maps and the aligned color filter array images, a single-frame blended RGB image at the first exposure level;
generate a single-frame blended negative color filter array image using aligned negative color filter array images, wherein the aligned negative color filter array images are generated using the multiple negative image frames;
generate, by a second artificial intelligence model using the single-frame blended negative color filter array image, a single-frame blended negative RGB image;
blend the single-frame blended RGB image at the first exposure level and the single-frame blended negative RGB image to create a high dynamic range (HDR) image; and
perform tone mapping on the HDR image to generate a low dynamic range (LDR) image for display.

18. The non-transitory machine readable medium of claim 17, wherein:
to generate the motion maps using the YUV image frames, the non-transitory machine readable medium further comprises instructions that when executed cause the at least one processor to align the YUV image frames using a first warp operation and generate the motion maps from the aligned YUV image frames;
to generate the aligned color filter array images using the RGB image frames, the non-transitory machine readable medium further comprises instructions that when executed cause the at least one processor to align the RGB image frames using a second warp operation and generate the aligned color filter array images from the aligned RGB image frames; and
the aligned negative color filter array images are generated from the multiple negative image frames using a third warp operation.

19. The non-transitory machine readable medium of claim 17, wherein, to train the first artificial intelligence model:
a training pair is obtained, wherein the training pair includes a ground truth RGB frame and input color filter array image frames;
motion noise augmentation is applied to the input color filter array image frames;
random patches are extracted from the ground truth RGB frame and the input color filter array image frames;
motion blur augmentation with a first probability is applied to the input color filter array image frames;
warp and halo blur augmentation with a second probability is applied to the input color filter array image frames; and
the input color filter array image frames are encoded as RGB frames to encourage residual learning.

20. The non-transitory machine readable medium of claim 17, wherein, to train the second artificial intelligence model:
a training pair is obtained, wherein the training pair includes a ground truth RGB frame and input color filter array image frames;
random patches are extracted from the ground truth RGB frame and the input color filter array image frames;
halo blur augmentation is applied to the input color filter array image frames;
the input color filter array image frames are averaged into a single input color filter array image; and
the single input color filter array image is encoded as an RGB frame to encourage residual learning.
